(19) United States
(12) Patent Application Publication
(10) Pub. No.: US 2022/0027389 A1
(43) Pub. Date: Jan. 27, 2022

(54) Identifier Association Method and Apparatus, and Electronic Device

(71) Applicant: Beijing Pinyou Interactive Information Technology Co., Ltd., Beijing (CN)

(72) Inventor: Geliang CHEN, Beijing (CN)

(21) Appl. No.: 16/476,110

(22) PCT Filed: May 22, 2019
(86) PCT No.: PCT/CN2019/087954

§ 371 Date: Jul. 5, 2019

(30) Foreign Application Priority Data
Apr. 16, 2019 (CN) 201910304951.0

(51) Int. Cl. G06F 16/28; G06F 16/215; G06F 16/23; G06F 16/2455; G06F 16/22

(52) U.S. Cl. CPC G06F 16/288; G06F 16/215; G06F 16/2228; G06F 16/2456; G06F 16/2365

(57) ABSTRACT

The present disclosure discloses an Identifier (ID) association method and apparatus, and an electronic device. The method includes that: user information is read, the user information including representation forms of IDs of multiple data sources; a user relationship indicated between each two IDs and a credibility index of each data source are extracted according to the representation forms of the IDs of the multiple data sources; a user relationship graph is constructed, the user relationship graph taking each ID as a point and taking the user relationship as a connecting edge; and the user relationship graph is regulated according to the credibility index to determine an ID connected graph of each user, each ID in the ID connected graph being associated and belonging to the same user.

### CROSS-REFERENCE TO RELATED APPLICATIONS

The present disclosure claims benefit of Chinese Patent Application No. 201910304951.0, submitted to the Patent Office of the People's Republic of China on Apr. 16, 2019, and entitled “Identifier (ID) Association Method and apparatus, and Electronic Device”, the contents of which are hereby incorporated by reference in its entirety.

### TECHNICAL FIELD

The present disclosure relates to the technical field of ID association, and in particular to an ID association method and apparatus, and an electronic device.

### BACKGROUND

The same user may have various IDs in different devices, for example, a Cookie account corresponding to a Personal Computer (PC) and an International Mobile Equipment Identity (IMEI) or Identifier For Advertising (IDFA) corresponding to a mobile device. In related art, it is usually necessary to find multiple IDs of the same user for different devices and applications to conveniently make statistics about using habits of the same user to implement merging. When determining that multiple IDs belong to the same user, data sets of different platforms and terminals are associated. A present manner is to collect ID data of different terminals, then extract a relationship that multiple IDs belong to the same user from the ID data and construct an ID connected graph to unify the IDs of the same user. However, such a technical solution of searching for the IDs of the same user has multiple disadvantages as follows.

At one, an ID merging rate is relatively low, a relatively small number of IDs may be associated, and plenty of IDs may not be effectively merged.

At two, recognition cost is relatively high, a recognition error rate is high and thus recognition accuracy is relatively low. For example: personal data of a user, social relationship data of the user, data generated by the user and behavioral data of the user are classified to obtain classified user data, and the classified user data is analyzed to determine whether the IDs belongs to the same user or not according to a probability of an algorithm model, which may obviously increase cost, in recognition of the same user and make the recognition error rate relatively high.

At three, an ID recognition result is unreasonable, credibility of a data source is not considered, or the credibility is manually set, and such a setting manner is unreasonable, which makes the result unreasonable.

For the above-mentioned problem, no effective solution has been provided yet.

### SUMMARY

At least some embodiments of the present disclosure provide an ID association method and apparatus, and an electronic device, so as at least partially to solve the technical problem of relatively low accuracy in recognition of IDs of the same user in the related art.

In an embodiment of the present disclosure, an ID association method is provided, which includes that: reading user information, the user information including representation forms of IDs of multiple data sources; extracting a user relationship indicated between each two IDs and a credibility index of each data source according to the representation forms of the IDs of the multiple data sources; constructing a user relationship graph, the user relationship graph taking each ID as a point and taking the user relationship as a connecting edge; and regulating the user relationship graph according to the credibility index to determine an ID connected graph of each user, each ID in the ID connected graph being associated and belonging to the same user.

In an optional embodiment, before reading the user information, further including: acquiring IDs of each user in the multiple data sources, different combination forms being adopted for the IDs of each data source; and performing at least one of the following operations: when determining that two IDs in the same time period belong to the same user, recording a first representation form of the two IDs; when determining that two IDs in the same time period are used for executing the same operation and the two IDs belong to the same user, recording a second representation form of the two IDs; and, when determining that one ID in the same time period is used for executing a target operation, recording a third representation form of the one ID.

In an optional embodiment, extracting the user relationship indicated between each two ID and the credibility index of each data source according to the representation forms of the IDs of the multiple data sources includes at least one of the following operations: extracting a first user relationship from the first representation form of the two IDs and the second representation form of the two IDs, and determining a first initial credibility index of a data source corresponding to the first user relationship, the first user relationship indicating the data source and a user relationship indicated between each two IDs; extracting a second user relationship from the second representation form of the two IDs and the third representation form of the one ID, and determining a second initial credibility index of a data source corresponding to the second user relationship; and extracting a third user relationship from the second representation form of the two IDs and the third representation form of the one ID, and determining a third initial credibility index of a data source corresponding to the third user relationship.

In an optional embodiment, extracting the second user relationship from the second representation form of the two IDs and the third representation form of the one ID and determining the second initial credibility index of the data source corresponding to the second user relationship includes: arranging the user information according to an acquired time sequence; detecting each time window after arranging the user information, a first time period being added to a present detection time point every time when a time window is detected; and when two IDs in the user information are different and the two IDs in the time window are used for executing different operations, determining the second user relationship and determining the second initial credibility index of the data source corresponding to the second user relationship.

In an optional embodiment, extracting the third user relationship from the second representation form of the two IDs and the third representation form of the one ID and determining the third initial credibility index of the data source corresponding to the third user relationship includes: arranging the user information according to an acquired time sequence; detecting each time window after arranging the user information, a second time period being added to a present detection time point every time when a time window is detected; and when two IDs in the user information are different and a ratio value that the two IDs in the time window are used for executing the same operation is higher than a preset ratio value, determining the third user relationship and determining the third initial credibility index of the data source corresponding to the third user relationship.

In an optional embodiment, constructing the user relationship graph includes: determining each ID as a point and creating a connecting edge corresponding to each user relationship; calculating credibility of each connecting edge according to the credibility index of each data source, a time decay coefficient of credibility of the user relationship and a time difference value between a time point when the user relationship occurs and a present time point; performing sequencing according to the credibility to obtain a sequencing result; and after performing sequencing, adding each connecting edge into the user relationship graph according to the sequencing result to construct the user relationship graph, one connecting path being between every two points in the user relationship graph.

In an optional embodiment, constructing the user relationship graph further includes: when determining that the user relationship is a first user relationship or a third user relationship, determining the connecting edge corresponding to the user relationship as a first-type edge, two IDs indicated by the first-type, edge belonging to the same user; and when determining that the user relationship is a second user relationship, determining the connecting edge corresponding to the user relationship as a second-type edge, the two IDs indicated by the second-type edge not belonging to the same user.

In an optional embodiment, regulating the user relationship graph according to the credibility index to determine the ID connected graph of each user includes: determining a first credibility index variation of each connecting edge and a second credibility index variation of each data source; regulating the credibility index of each data source according to the first credibility index variation and the second credibility index variation; and regulating the user relationship graph according to the regulated credibility index to determine the ID connected graph of each user.

In an optional embodiment, determining the first credibility index variation of each connecting edge includes: for a connecting edge that is not added to the user relationship graph, determining a first credibility index sub-variation according to a type of the connecting edge; for a connecting edge that has been added to the user relationship graph, accumulating a credibility index variation to obtain a second credibility index sub-variation; and determining the first credibility index variation according to the first credibility index sub-variation and the second credibility index sub-variation.

In an optional embodiment, determining the ID connected graph of each user includes: acquiring a point number of each maximal connected branch in the user relationship graph, the maximal connected branch including multiple points; when determining that the point number of the maximal connected branch exceeds a preset point number, obtaining an ID code corresponding to the maximal connected branch, the ID code being obtained by encrypting a result for splicing a data source of each of all IDs in the maximal connected branch and all IDs in the maximal connected branch, and the ID code indicating that all IDs in the maximal connected branch belong to the same user; and determining the maximal connected branch indicated by the ID code as an ID connected branch of the same user to determine the ID connected graph corresponding to each user.

In an optional embodiment, after determining the ID connected graph of each user, further including: acquiring new user information; analyzing the new user information to determine a new connecting edge; extracting a new ID code belonging to the same user according to the new connecting edge; and accessing an ID code maintenance table, and, when determining that an old ID code in the ID code maintenance table is the same as the new ID code, merging the old ID code and the new ID code, and determining that a user indicated by the old ID code and a user indicated by the new ID code are the same user, the ID code maintenance table recording modification information of ID codes.

In an optional embodiment, after reading the user information, further including: executing a cleaning operation on the user information, the cleaning operation at least including data format cleaning and numerical range exception cleaning, the data format cleaning indicating cleaning of data inconsistent with a preset data format and the numerical range exception cleaning indicating cleaning of data inconsistent with the representation forms of the IDs.

In another embodiment of the present disclosure, an ID association apparatus is provided, which includes: a reading element, configured to read user information, the user information including representation forms of IDs of multiple data sources; an extraction element, configured to extract a user relationship indicated between each two IDs and a credibility index of each data source according to the representation forms of the IDs of the multiple data sources; a construction element, configured to construct a user relationship graph, the user relationship graph taking each ID as a point and taking the user relationship as a connecting edge; and a determination element, configured to regulate the user relationship graph according to the credibility indexes to determine an ID connected graph of each user, each ID in the ID connected graph being associated and belonging to the same user.

In an optional embodiment, ID association apparatus further includes: a first acquisition element, configured to, before reading the user information, acquire IDs of each user in the multiple data sources, different combination forms being adopted for the IDs of each data source; and a recording element, configured to perform at least one of the following, operations: when determining that two IDs in the same time period belong to the same user, record a first representation form of the two IDs; when determining that two IDs in the same time period are used for executing the same operation and the two IDs belong to the same user, record a second representation form of the two IDs; and, when determining that one ID in the same time period is used for executing a target operation, record a third representation form of the one ID.

In an optional embodiment, the extraction element includes: a first extraction component, configured to extract a first user relationship from the first representation form of the two IDs and the second representation form of the two IDs and determine a first initial credibility index of a data source corresponding to the first user relationship, the first user relationship indicating the data source and a user relationship indicated between each two IDs; a second extraction component, configured to extract a second user relationship from the second representation form of the two IDs and the third representation form of the one ID and determine a second initial credibility index of a data source corresponding to the second user relationship; and a third extraction component, configured to extract a third user relationship from the second representation form of the two IDs and the third representation form of the one ID and determine a third initial credibility index of a data source corresponding to the third user relationship.

In an optional embodiment, the second extraction component includes: a first arrangement subcomponent, configured to arrange the user information according to an acquired time sequence; a first detection subcomponent, configured to detect each time window after arranging the user information, a first time period being added to a present detection time point every time when a time window is detected; and a first determination subcomponent, configured to, when two IDs in the user information are different and the two IDs in the time window are used for executing different operations, determine the second user relationship and determine the second initial credibility index of the data source corresponding to the second user relationship.

In an optional embodiment, the third extraction component includes: a second arrangement subcomponent, configured to arrange the user information according to the acquired time sequence; a second detection subcomponent, configured to detect each time window after arranging the user information, a second time period being added to a present detection time point every time when a time window is detected; and a second determination subcomponent, configured to, when two IDs in the user information are different and a ratio value that the two IDs in the time window are used for executing the same operation is higher than a preset ratio value, determine the third user relationship and determine the third initial credibility index of the data source corresponding to the third user relationship.

In an optional embodiment, the construction element includes: a first determination component, configured to determine each ID as a point and create a connecting edge corresponding to each user relationship; a calculation component, configured to calculate credibility of each connecting edge according to the credibility index of each data source, a time decay coefficient of credibility of the user relationship and a time difference value between a time point when the user relationship occurs and a present time point; a first sequencing component, configured to perform sequencing according to the credibility to obtain a sequencing result; and a construction component, configured to, after performing sequencing, add each connecting edge into the user relationship graph according to the sequencing result to construct the user relationship graph, one connecting path being between every two points in the user relationship graph.

In an optional embodiment, the construction element further includes: a second determination component, configured to, when determining that the user relationship is a first user relationship or a third user relationship, determine the connecting edge corresponding to the user relationship as a first-type edge, two IDs indicated by the first-type edge belonging to the same user; and a third determination component, configured to, when determining that the user relationship is a second user relationship, determine the connecting edge corresponding to the user relationship as a second-type edge, the two IDs indicated by the second-type edge not belonging to the same user.

In an optional embodiment, the determination element includes: a fourth determination component, configured to determine a first credibility index variation of each connecting edge and a second credibility index variation of each data source; a regulation component, configured to regulate the credibility index of each data source according to the first credibility index variation and the second credibility index variation; and a fifth determination component, configured to regulate the user relationship graph according to the regulated credibility index to determine the ID connected graph of each user.

In an optional embodiment, the fourth determination component includes: a third determination subcomponent, configured to, for a connecting edge that is not added to the user relationship graph, determine a first credibility index sub-variation according to a type of the connecting edge; an accumulation subcomponent, configured to, for a connecting edge that has been added to the user relationship graph, accumulate a credibility index variation to obtain a second credibility index sub-variation; and a fourth determination subcomponent, configured to determine the first credibility index variation according to the first credibility index sub-variation and the second credibility index sub-variation.

In an optional embodiment, the fifth determination component includes: a second acquisition subcomponent, configured to acquire a point number of each maximal connected branch in the user relationship graph, the maximal connected branch including multiple points; a third acquisition subcomponent, configured to, when determining that the point number of the maximal connected branch exceeds a preset point number, obtain an ID code corresponding to the maximal connected branch, the ID code being obtained by encrypting a result for splicing a data source of each of all IDs in the maximal connected branch and all IDs in the maximal connected branch, and the ID code indicating that all of the IDs in the maximal connected branch belong to the same user; and a fifth determination subcomponent, configured to determine the maximal connected branch indicated by the ID code as an ID connected branch of the same user to determine the ID connected graph corresponding to each user.

In an optional embodiment, the ID association apparatus further includes: a second acquisition element, configured to, after the ID connected graph of each user is determined, acquire new user information; an analysis element, configured to analyze the new user information to determine a new connecting edge; a second extraction element, configured to extract a new ID code belonging to the same user according to the new connecting edge; and an access element, configured to access an ID code maintenance table, and when determining that an old ID code in the ID code maintenance table is the same as the new ID code, merge the old ID code and the new ID code, and determining that a user indicated by the old ID code and a user indicated by the new ID code are the same user, the ID code maintenance table recording modification information of ID codes.

In an optional embodiment, the ID association apparatus further includes: a cleaning element, configured to, after the user information is read, are used for executing a cleaning operation on the user information, the cleaning operation at least including data format cleaning and numerical range exception cleaning, the data format cleaning indicating cleaning of data inconsistent with a preset data format and the numerical range exception cleaning indicating cleaning, of data inconsistent with the representation forms of the IDs.

In another embodiment of the present disclosure, an electronic device is also provided, which includes: a processor; and a memory, configured to store at least one executable instruction of the processor, the processor being configured to execute the at least one executable instruction to execute above-mentioned ID association method.

In another embodiment of the present disclosure, a storage medium is also provided, which includes a stored program, the stored program running to control a device where the storage medium is located to execute above-mentioned ID association method.

In the at least some embodiments of the present disclosure, the user information is read, the user information including the representation forms of the IDs of the multiple data sources; the user relationship indicated between each two IDs and the credibility index of each data source are extracted according to the representation forms of the IDs of the multiple data sources; the user relationship graph is constructed, the user relationship graph taking each ID as a point and taking the user relationships as a connecting edge; and the user relationship graph is regulated according to the credibility index to determine the ID connected graph of each user, each ID in the ID connected graph being associated and belonging to the same user. In the embodiments, the user relationship indicated between each two. IDs and the credibility index of each data source may be automatically extracted, and the user relationship graph is regulated according to the credibility index, so that unreasonable user ID recognition is avoided to improve an ID merging rate and accuracy of user recognition and further solve the technical problem of relatively low accuracy in recognition of IDs of the same user in the related art.

### BRIEF DESCRIPTION OF THE DRAWINGS

The drawings described here are adopted to provide a further understanding to the present disclosure and form a part of the application. Schematic embodiments of the present disclosure and descriptions thereof are adopted to explain the present disclosure and not intended to form improper limits to the present disclosure. In the drawings:

FIG. 1 is a flowchart of an ID association method according to an optional embodiment of the present disclosure.

FIG. 2 is a schematic diagram of constructing a user relationship graph according to an optional embodiment of the present disclosure.

FIG. 3 is a schematic diagram of regulating credibility according to an optional embodiment of the present disclosure.

FIG. 4 is structural block diagram of an ID association apparatus according to an optional embodiment of the present disclosure.

### DETAILED DESCRIPTION

In order to make those skilled in the art understand the solutions of the present disclosure better, the technical solutions in the embodiments of the present disclosure will be clearly and completely described below in combination with the drawings in the embodiments of the present disclosure. It is apparent that the described embodiments are not all embodiments but only a part of the embodiments of the present disclosure. All other embodiments obtained by those of ordinary skill in the art on the basis of the embodiments in the present disclosure without creative work shall fall within the scope of protection of the present disclosure.

It is to be noted that the terms like “first” and “second” in the specification, the claims and the accompanying drawings of the present disclosure are used for differentiating the similar objects, but do not have to describe a specific order or a sequence. It should be understood that data used like this may be exchanged under a proper condition for implementation of the embodiments of the present disclosure described here in sequences besides those shown or described herein. In addition, terms “include” and “have” and any transformation thereof are intended to cover nonexclusive inclusions. For example, a process, method, system, product or device including a series of steps or elements is not limited to those clearly listed steps or elements, but may include other steps or elements which are not clearly listed or inherent in the process, the method, the system, the product or the device.

For making it convenient for a user to understand the present disclosure, part of terms or nouns involved in each embodiment of the present disclosure will be explained below.

Symbol: “!=”: unequal.

Graph: a model, a user relationship graph in the application, a graph including a plurality of “points” and a plurality of “edges” of which each connects two points.

Path: a path is formed by connecting a plurality of “edges”.

Forest: one of graph models, there being at most only one (or no) “path” between any two points in a forest model.

The following optional embodiments of the present disclosure may be applied to various user ID recognition environments. For example, for digital marketing of an enterprise, it is necessary to implement different recognition on a user in multiple channels to determine that multiple IDs belong to the same user, which may greatly expand data information of the same user and is also significant for data mining. In the following optional embodiments of the present disclosure, credibility of a data source may be automatically regulated and unreasonable. ID recognition and user recognition results may be avoided, so that an ID merging rate and accuracy of user recognition are improved. Each optional embodiment of the present disclosure will be described below in detail.

In an embodiment of the present disclosure, an ID association method embodiment is provided. It is to be noted that the steps shown in the flowchart of the drawings may be executed in a computer system like a set of computer executable instructions, and moreover, although a logic sequence is shown in the flowchart, the shown or described steps may be executed in a sequence different from that described here under some conditions.

FIG. 1 is a flowchart of an ID association method according to an optional embodiment of the present disclosure. As shown in FIG. 1, the method includes the following steps.

At step S102, user information is read, the user information including representation forms of IDs of multiple data sources.

At step S104, a user relationship indicated between each two IDs and a credibility index of each data source are extracted according to the representation forms of the IDs of the multiple data sources.

At step S106, a user relationship graph is constructed, the user relationship graph taking each ID as a point and taking the user relationship as a connecting edge.

At step S108, the user relationship graph is regulated according to the credibility index to determine an ID connected graph of each user, each ID in the ID connected graph being associated and belonging to the same user.

Through the steps, the user information is read, the user information including the representation forms of the IDs of the multiple data sources; the user relationship indicated between each two IDs and the credibility index of each data source are extracted according to the representation forms of the IDs of the multiple data sources; the user relationship graph is constructed, the user relationship graph taking each ID as a point, and taking, the user relationship as a connecting edge; and the user relationship graph is regulated according to the credibility index to determine the ID connected graph of each user, each ID in the ID connected graph being associated and belonging to the same user. In this embodiment, the user relationship indicated between each two IDs and the credibility index of each data source may be automatically extracted, and the user relationship graph is regulated according to the credibility index, so that unreasonable user ID recognition is avoided to improve an ID merging rate and accuracy of user recognition and further solve the technical problem of relatively low accuracy in recognition of IDs of the same user in the related art.

Each optional embodiment of the present disclosure will be described below in detail.

At step S102, user information is read, and the user information includes-representation forms of IDs of multiple data sources.

In an optional embodiment, before the step that the user information is read, the method further includes that: the IDs of each user in the multiple data sources are acquired, different combination forms being adopted for the IDs of each data source; and at least one of the following operations is performed: when determining that two IDs in the same time period belong to the same user, a first representation form of the two IDs is recorded; when determining that two IDs in the same time period are used for executing the same operation and the two IDs belong to the same user, a second representation form of the two IDs is recorded; and, when determining that one ID in the same time period is used for executing a target operation, a third representation form of the one ID is recorded.

The data source includes, but not limited to, a traffic platform, a third-party monitoring platform, first-party data and the like.

The three representation forms of the IDs may be executed concurrently or executed independently. That is, the first representation form of the two IDs and the second representation form of the two Ds may be executed concurrently, may also be executed independently, and form an “and/or” relationship. Similarly, it can be understood that the “and/or” relationship is formed between the first representation form of the two IDs and the third representation form of the one ID and between the second representation form of the two IDs and the third representation form of the one ID.

The combination form for IDs includes, but not limited to: IMEI or IDFA (which may be obtained through a mobile device), a MAC account (which may be obtained through a device such as a Mac book) and cookie (which may be obtained through an ordinary PC).

In an optional embodiment, the first representation form of the two IDs is: “ID₁=ID₂, time period t”, and the record in this form indicates that the ID₁ and the ID₂ belong to the same user at a time period t. The second representation form of the two IDs is: “ID₁=ID₂, behavior, time period t”, and the record in this form indicates that ID₁ and ID₂ belong to the same user at the time period t and the user executes a certain operation/behavior (for example, browsing the web); and the third representation form of the one ID is: “ID, behavior, time period t”, and the record in this form indicates that the one ID is used for executing a certain operation or behavior at the time period t.

In another optional embodiment, after the step that the user information is read, the method further includes that: a cleaning operation is executed on the user information, the cleaning operation at least including data format cleaning and numerical range exception cleaning, the data format cleaning indicating cleaning of data inconsistent with a preset data format and the numerical range exception cleaning indicating cleaning of data inconsistent with the representation forms of the IDs.

That is, after the user information is read, content against a specific rule in the information, for example, the data inconsistent with the preset data format and a numerical range exception, is deleted.

At step S104, a user relationship indicated between each two IDs and a credibility index of each data source are extracted according to the representation forms of the IDs of the multiple data sources.

In the embodiment of the present disclosure, the step that the user relationship indicated between each two IDs and the credibility index of each data source are extracted according to the representation forms of the IDs of the multiple data sources includes at least one of the following operations: a first user relationship is extracted from the first representation form of the two IDs and the second representation form of the two IDs, and a first initial credibility index of the data source corresponding to the first user relationship is determined, the first user relationship indicating the data source and a user relationship between each two IDs; a second user relationship is extracted from the second representation form of the two IDs and the third representation form of the one ID, and a second initial credibility index of a data source corresponding to the second user relationship is determined; and a third user relationship is extracted from the second representation form of the two IDs and the third representation form of the one ID, and a third initial credibility index of the data source corresponding to the third user relationship is determined.

Extraction of the three user relationships may be executed concurrently or executed independently. That is, extraction of the first user relationship and extraction of the second user relationship may be executed concurrently, may also be executed independently, and form an “and/or” relationship. Similarly, it can be understood that the “and/or” relationship is formed between extraction of the first user relationship and the third user relationship and between extraction of the second user relationship and the user relationship.

All of kᵢ, δ, ε, θ, ϕ and α involved in the following embodiments of the present disclosure are constant and may be set by developers or others. There are no specific limits made in the application.

That is, three relationship extraction manners are adopted in the optional embodiments of the present disclosure.

For a First Extraction Manner

The step that first user relationship is extracted from the first representation form of the two IDs and the second representation form of the two IDs and the first initial credibility index of the data source corresponding to the first user relationship is determined may refer to that: a relationship like “source=X, ID₁ and ID₂ belong to the same user” is extracted from the first representation form of the two IDs and the second representation form of the two IDs, and an initial credibility index Aⱼ of the data source (which may also be understood as a relationship source) is set. The first relationship extraction manner is to extract the user relationship from the data source specifically indicating that “ID₁ and ID₂ belong to the same user”, and is also a common relationship extraction method. Compared with the data sources in the following two manners, data of this type specifically indicates a relationship between two IDs and thus is higher in accuracy.

In an optional embodiment, the data source further includes, but not limited to, an advertisement log, a social login log and the like. The credibility indexes in the first extraction manner are different.

For a Second Extraction Manner

The step that the second user relationship is extracted from the second representation form of the two IDs and the third representation form of the one ID and the second initial credibility index of the data source corresponding to the second user relationship is, determined includes that: the user information is arranged according to an acquired time sequence; each time window is detected after arranging the user information, a first time period being added to a present detection time point every time when a time window is detected; and when two IDs in the user information are different and the two IDs in the time window are used for executing different operations, the second user relationship is determined, and the second initial credibility index of the data source corresponding to the second user relationship is determined.

When determining that two IDs in the user information are different, the two IDs may not belong to the same user.

That is, the manner for extracting the user relationship from the second representation form of the two IDs and the third representation form of the one ID is as follows. At first, the user information is arranged according to the acquired time sequence, then each time window [t, t+ε] is checked (c (corresponding to the first time period) is added to t every time when a window is checked), and when ID₁!=ID₂ and there are two different behaviors in a certain time window, a relationship “source=‘a second relationship extraction manner’, ID₁ and ID₂ do not belong to the same user” is added and the initial credibility index Aⱼ of the data source (i.e., the relationship source) is set. According to the second extraction manner, it is necessary to determine IDs executing different operations within an extremely short time as different users to avoid such an unreasonable phenomenon that “the same user executes two operations within an extremely short time (which may be a few milliseconds)” in a recognition result. Each data source in the second extraction manner is also different and different from the data sources in the first extraction manner,

For a Third Extraction Manner

In an optional embodiment, the step that the third user relationship is extracted from the second representation form of the two IDs and the third representation form of the one ID and the third initial credibility index of the data source corresponding to the third user relationship is determined includes that: the user information is arranged according to the acquired time sequence; each time window is detected after arranging the user information, a second time period being added to the present detection time point every time when a time window is detected; and when two IDs in the user information are different and a ratio value that the two IDs in the time window are used for executing the same operation is higher than a preset ratio value, the third user relationship is determined, and the third initial credibility index of the data source corresponding to the third user relationship is determined.

That is, the manner for extracting the user relationship from the second representation form of the two IDs and the third representation form of the one ID is as follows. At first, the user information is arranged according to the acquired time sequence, then each time window [t, t+δ] is checked (δ (corresponding to the second time period) is added to t every time when a window is checked), and when ID₁!=ID₂ and a ratio value (obtained by a consistent behavior number is divided by a behavior number after behaviors of the two IDs are merged) that the two IDs are used for executing the same operation or behavior in the time window is higher than 8 (the preset ratio value), a relationship “source=‘a third relationship extraction manner’, and ID₂ belong to the same user” is added and the initial credibility index Aⱼ of the data source (i.e., the relationship source) is set. The third extraction manner may be considered as a supplement to the common extraction method (the first extraction manner), and is intended to extract more relationships that “two IDs belong to the same user”. Since not all of the data includes multiple IDs at present, when behavioral data including a single ID (the third representation form of the one ID) may be utilized and then that “two IDs belong to the same user” may be deduced by comparing overlapped portions of two pieces of behavioral data, more user relationships may be extracted. The data sources in the third extraction manner are different from the data sources in the first extraction manner and the second extraction manner, that is, when there are n data sources in the first extraction manner, there may be totally n+1 credibility indexes A₁, A₂, . . . , Aₙ₊₂.

At step S106, a user relationship graph is constructed, the user relationship graph taking each ID as a point and taking the user relationship as a connecting edge.

In the embodiment of the present disclosure, the step that the user relationship graph is constructed includes that: each ID is determined as a point, and a connecting edge corresponding to each user relationship is created; credibility of each connecting edge is calculated according to the credibility index of each data source, a time decay coefficient of credibility of the user relationship and a time difference value between a time point when the user relationship occurs and a present time point; sequencing is performed according to the credibility to obtain a sequencing result; and after performing sequencing, each connecting edge is added into the user relationship graph according to the sequencing result to construct the user relationship graph, and one connecting path is between every two points in the user relationship graph.

That is, each ID may be taken as a point, each user relationships may be taken as a connecting edge, and the credibility of each connecting edge is calculated according to the credibility index, the time decay coefficient of the credibility of the user relationship and the time difference value between the time point, when the user relationship occurs, and the present time point. In an optional embodiment, a calculation formula for calculating each credibility is as follows: for each data source i, the credibility of each user relationship is

$$S = \frac{{e}^{- {k}_{1} t}}{1 + {e}^{- {A}_{t}}} ,$$

kᵢ being the time decay coefficient of the credibility of the relationship. The credibility of each relationship decays along with time, and kᵢ determines a decay speed thereof. Aᵢ is the credibility index of the relationship source, and t is a time period between a time point, when the user relationship occurs, and a present time point. For example, for the user relationship in the first extraction manner, t is a difference between record time point and the present time point (each user relationship in the first extraction manner is extracted from a certain record, this record usually includes a time point when each user relationship occurs, and moreover, when the user information does not include the time point, t=0). For each user relationship in the second extraction manner and the third extraction manner, t is a difference between a left endpoint of the time window and the present time.

For the user relationship graph, there is one connecting path between every two points. For example, there are three points A, B and C, and when an edge AB and an edge BC have existed in the user relationship graph, an edge AC may not exist because a path A-B-C formed by connecting the edge AB and the edge AC has existed between A and C.

After the credibility are calculated, sequencing, for example, descending processing, may be performed according to the credibility, and then the connecting edge corresponding to each user relationship is added into the user relationship graph. The connecting edges are gradually added into the user relationship graph with one connecting path between every two points.

In an optional embodiment of the present disclosure, the step that the user relationship graph is constructed further includes that: when determining that the user relationship is a first user relationship or a third user relationship (for example, determining that two IDs involved in the user relationship belong to the same user), the connecting edge corresponding to the user relationship is determined as a first-type edge, the two IDs indicated by the first-type edge belonging to the same user; and when determining that the user relationship is a second user relationship (for example, determining that the two IDs involved in the user relationship do not belong to the same user), the connecting edge corresponding to the user relationship is determined as a second-type edge, the two IDs indicated by the second-type edge not belonging to the same user.

That is, when determining that the user relationship is the first user relationship or the third user relationship, it may be determined that the two IDs involved in the user relationship belong to the same user, and then the connecting edge corresponding to the user relationship is determined as a first-type edge. In addition, when determining that the user relationship is the second user relationship, it is determined that the two IDs involved in the user relationship do not belong to the same user, and in such case, the connecting edge corresponding to the user relationship is determined as the second-type edge.

In an optional embodiment, the first-type edge may be understood as a “straight edge”, and the second-type edge may be understood as a “curved edge”.

In the embodiment of the present disclosure, when determining that the user relationship is that “two IDs belong to the same user”, the added edge is called a “straight edge”, otherwise is called a “curved edge”. In addition, when the rule that “there is one path between every two points” may be broken after the connecting edge corresponding to a user relationship is added to the user relationship graph, the connecting edge is not added. After all of the relationships are added or not added, the user relationship graph is finally obtained, and this graph is a forest.

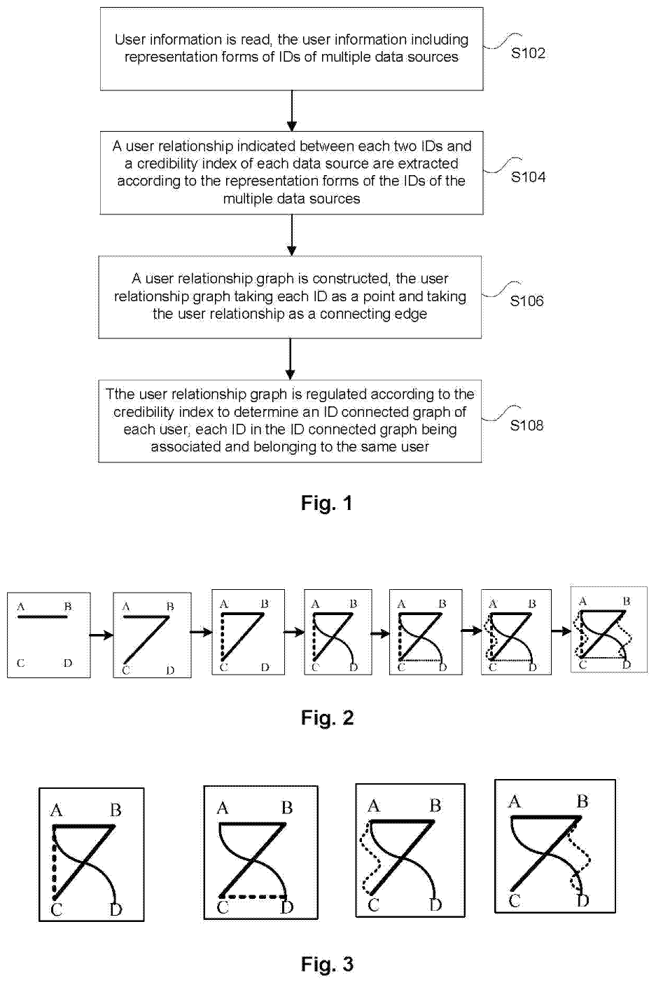

FIG. 2 is a schematic diagram of constructing a user relationship graph according to an optional embodiment of the present disclosure. As shown in FIG. 2, there are four IDs, i.e., A, B, C and D respectively, including seven relationships in Table One, a graph, construction process is shown in FIG. 2, and from left to right, solid lines represent connecting edges actually added into the user relationship graph and dashed lines represent connecting edges not added into the user relationship graph. When the credibility index of each data source is not regulated later, it is determined that A, B and C belong to the same user and D belongs to another user.

TABLE ONE
Construction of User Relationship Graph

| Credibility | User relationship | Data source | Connecting edge |
|---|---|---|---|
| 0.9 | A and B belong to the | Source X | Straight edge |
| | same user | | connecting A and B |
| 0.8 | B and C belong to the | Source Y | Straight edge |
| | same user | | connecting B and C |
| 0.7 | A and C belong to the | Source Z | Straight edge |
| | same user | | connecting A and C |
| 0.6 | A and D do not belong | Second | Curved edge |
| | to the same user | extraction | connecting A and D |
| | | manner | |
| 0.5 | C and D belong to the | Third | Straight edge |
| | same user | extraction | connecting C and D |
| | | manner | |
| 0.4 | A and C do not belong | Second | Curved edge |
| | to the same user | extraction | connecting A and C |
| | | manner | |
| 0.3 | B and D do not belong | Second | Curved edge |
| | to the same user | extraction | connecting B and D |
| | | manner | |

At step S108, the user relationship graph is regulated according to the credibility indexes to determine an ID connected graph, of each user, each ID in the ID connected graph being associated and belonging to the same user.

In the embodiment of the present disclosure, the step that the user relationship graph is regulated according to the credibility indexes to determine the ID connected graph of each user includes that: a first credibility index variation of each connecting edge and a second credibility index variation of each data source are determined; the credibility index of each data source is regulated according to the first credibility index variation and the second credibility index variation; and the user relationship graph is regulated according to the regulated credibility indexes to determine the ID connected graph of each user.

Two credibility index variations are involved in the above manner.

For the first credibility index variation, a credibility index variation of each connecting edge is calculated.

In an optional embodiment, the step that the first credibility index variation of each connecting edge includes that: for a connecting edge that is not added to the user relationship graph, a first credibility index sub-variation is determined according to a type of the connecting edge; for a connecting edge that has been added to the user relationship graph, a credibility index variation is accumulated to obtain a second credibility index sub-variation; and the first credibility index variation is determined according to the first credibility index sub-variation and the second credibility index sub-variation.

For a connecting edge e that is not added into the graph, the credibility is c, and paths of two endpoints of the connecting edge e are (e₁, e₂, . . . , eₙ) with credibility c₁, c₂, . . . , cₙ respectively, and include m “curved edges” and n−m “straight edges”. “Credibility index variations” of e and (e₁, e₂, . . . , eₙ) are Δ, Δ₁, Δ₁, Δₙ, . . . , Δₙ respectively.

The credibility index variations may be divided into four conditions for discussions.

At one, e is a straight edge and m=0:

$$Δ = min \text{?} \{ {c}_{t} \} , {Δ}_{t} = \frac{c}{n} . \\ \text{?} \text{indicates text missing or illegible when filed}$$

At two, e is a curved edge and m=0:

$$Δ = - min \text{?} \{ {c}_{t} \} , {Δ}_{t} = - \frac{c}{n} . \\ \text{?} \text{indicates text missing or illegible when filed}$$

At three, e is a straight edge and m>0:

$$Δ = - {min}_{{e}_{t} is curved edge} \{ {c}_{i} \} , {Δ}_{i} = - \frac{c}{m} .$$

At four, e is a curved edge and m>0:

$$Δ = {min}_{{e}_{t} is curved edge} \{ {c}_{i} \} , {Δ}_{i} = \frac{c}{m} .$$

For each connecting edge that is not added into the user relationship graph, the credibility index variation is calculated according to the above manner. For each connecting edge that has been added into the user relationship graph, each calculated “credibility index variation” is accumulated.

For the second credibility index variation, the credibility index variation of each data source is calculated.

It is set that a data source i has Nᵢ connecting edges eᵢ₁, eᵢ₂, . . . e_{iN}_{ᵢ} and the “credibility index variations” of each connecting edge are Δᵢ₁, Δᵢ₂, . . . , Δ_{i,N}_{ᵢ}, a credibility index variation of a data source j is

$${D}_{t} = \frac{{\sum }_{1 \leq j \leq {N}_{t}} {Δ}_{ij}}{{N}_{i}} .$$

After the credibility index variation is calculated, the “credibility index” of each data source may be updated. It is set that an original credibility index of the data source i is Aᵢ, an updated credibility index is Aᵢ+αDᵢ, Aᵢ being the credibility index of the data source i, α being a learning rate, 0<α≤1 and Di being the “credibility index variation” of the data source i.

FIG. 3 is a schematic diagram of regulating credibility according to an optional embodiment of the present disclosure. As shown in FIG. 3, there are four IDs, i.e., A, B, C and D respectively, initial credibility indexes thereof are shown in Table Two, seven relationships in Table One are included, and in the graph construction process, four edges are not added into the user relationship graph. Then, a process of regulating the credibility of the sources includes the following contents.

For the first subfigure from the left side in FIG. 3, Δ=min(0.9, 0.8)=0.8, Δ_{AB}=½·0.7=0.35, ΔBC=½*0.7=0.35.

For the second subfigure from the left side in FIG. 3, Δ=−min(0.6)=−0.6, Δ_{AD}=−0.5.

For the third subfigure from the left side in FIG. 3, Δ=−min(0.9, 0.8)=−0.8, Δ_{AB}=−½*0.4=−0.2, Δ_{BC}=−½*0.4=−0.2.

For the fourth subfigure from the left side in FIG. 3, Δ=min{0.6}=0.6, Δ_{AD}=0.3.

TABLE TWO
Regulation of Credibility Indexes

| | | | Initial | Regulated |
|---|---|---|---|---|
| Credi- | | Data | credibility | credibility |
| bility | User relationship | source | index | index |
| 0.9 | A and B belong to the | Source X | 10 | 10 + (0.35 − |
| | same user | | | 0.2) = 10.15 |
| 0.8 | B and C belong to the | Source Y | 5 | 5 + (0.35 − |
| | same user | | | 0.2) = 5.15 |
| 0.7 | A and C belong to the | Source Z | 3 | 3 + 0.8 = 3.8 |
| | same user | | | |
| 0.6 | A and D do not belong | Second | 2 | 2 + (−0.5 − |
| | to the same user | extraction | | 0.8 + 0.6 + |
| | | manner | | 0.3) I3 = 1.87 |
| 0.5 | C and D belong to the | Third | 2 | 2 − 0.6 = 1.4 |
| | same user | extraction | | |
| | | manner | | |
| 0.4 | A and C do not belong | Second | 2 | 2 + (−0.5 − |
| | to the same user | extraction | | 0.8 + 0.6 + |
| | | manner | | 0.3) I3 = 1.87 |
| 0.3 | B and D do not belong | Second | 2 | 2 + (−0.5 − |
| | to the same user | extraction | | 0.8 + 0.6 + |
| | | manner | | 0.3) I3 = 1.87 |

Through the above manner, the credibility indexes may be regulated.

Through the abovementioned implementation modes of the present disclosure, a wider data range may be utilized, and more manners for extracting merging relationships of the IDs may be adopted (the user relationships are not simultaneously extracted from the data in the three forms by a conventional method), so that the ID merging rate is increased. The user relationship that “two IDs may not be merged” is extracted from the second extraction manner, and this relationship is utilized in the process of constructing the user relationship graph, so that unreasonable ID merging is avoided, the merging accuracy is improved, and meanwhile, the ID recognition accuracy may also be improved. Finally, the credibility of the data sources may be learned and automatically updated to distinguish trusted and un-trusted data sources in an iteration process, so that accuracy of the selected relationship is improved, and the merging accuracy is further improved.

Then, an ID code, i.e., a unique ID, which may be called a super-ID, may be defined for each maximal connected branch in the constructed user relationship graph. The super-ID identifies the user to which all of IDs in the corresponding connected branch belong.

In the embodiment of the present disclosure, the step that the ID connected graph of each user is determined includes that: a point number of each maximal connected branch in the user relationship graph is acquired, the maximal connected branch including multiple points; when determining that the point number of the maximal connected branch exceeds a preset point number, an ID code corresponding to the maximal connected branch is obtained, the ID code being obtained by encrypting a result for splicing a data source of each of all IDs in the maximal connected branch and all IDs in the maximal connected branch, and the ID code indicating that all IDs in the maximal connected branch belong to the same user; and the maximal connected branch indicated by the ID code is determined as an ID connected branch of the same user to determine the ID connected graph corresponding to each user.

That is, when the super-ID is acquired, all of the IDs in the maximal connected graph in the user relationship graph may be sequenced by taking an ID source as a first keyword and taking the ID as a second keyword, and then all “ID sources_ID” are spliced with underlines “_” and are finally encrypted with md5 to obtain the super-ID.

In an optional embodiment, after the step that the ID connected graph of each user is determined, the method further includes that: new user information is acquired; the new user information is analyzed to determine a new connecting edge; a new ID code belonging to the same user is extracted according to the new connecting edge; and an ID code maintenance table is accessed, and when determining that an old ID code in the ID code maintenance table is the same as the new ID code, the old ID code and the new ID code are merged and it is determined that a user indicated by the old ID code and a user indicated by the new ID code are the same user, the ID code maintenance table recording modification information of ID codes.

That is, for reducing maintenance cost of super-IDs when records are added, a super-ID maintenance mechanism is accompanied, including the following operations:

when there is a new record (i.e., new user information), the new record is processed in the abovementioned processing manner; and a relationship that “two super-IDs belong to the same user” is extracted (a relationship that “two super-IDs do not belong to the same user” is not extracted) according to a new connecting edge in the user relationship graph, and the super-ID with a latter dictionary order is modified into a super-ID with an earlier dictionary order.

In addition, in the embodiment of the present disclosure, a table (i.e., the ID code maintenance table) may also be maintained, and this table records each super-ID and the super-ID into which it is modified or that it is never modified. Every time when an application initiates a request about an old super-ID, the table is accessed, the new super-ID corresponding to the old super-ID is found, and information about the new super-ID is returned.

Through the abovementioned embodiments, behavioral data including single IDs, non-behavioral data including multiple IDs and behavioral data including multiple IDs may be utilized at the same, the user relationships, are extracted in the three extraction manners, including extraction of the relationships that “two IDs belong to the same user” and “two IDs do not belong to the same user”, the user relationship graph is constructed according to the extracted relationships, and user recognition is performed to obtain each ID belonging to the same user. In addition, data maintenance may be implemented without recalculating old data, so that maintenance cost is reduced, a user ID recognition result is more accurate, and the rate of obtaining an unreasonable recognition result is reduced.

The present disclosure will be described below through another optional embodiment.

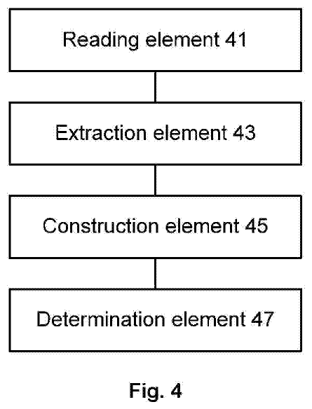

FIG. 4 is structural block diagram of an ID association apparatus according to an optional embodiment of the present disclosure. As shown in FIG. 4, the ID association apparatus includes:

a reading element 41, configured to read user information, the user information including representation forms of IDs of multiple data sources;

an extraction element 43, configured to extract a user relationship indicated between each two IDs and a credibility index of each data source according to the representation forms of the IDs of the multiple data sources;

a construction element 45, configured to construct a user relationship graph, the user relationship graph taking each ID as a point and taking the user relationship as a connecting edge; and

a determination element 57, configured to regulate the user relationship graph according to the credibility indexes to determine an ID connected graph of each user, each ID in the ID connected graph being associated and belonging to the same user.

Through the ID association apparatus, the user information is read is through the reading element 41, the user information including the representation forms of the IDs of the multiple data sources; the user relationship indicated between each two. IDs and the credibility index of each data source are extracted through the extraction element 43 according to the representation forms of the IDs of the multiple data sources; the user relationship graph is constructed through the construction element 45, the user relationship graph taking each ID as a point and taking the user relationship as a connecting edge; and the user relationship graph is regulated through the determination element 47 according to the credibility indexes to determine the ID connected graph of each user, each ID in the ID connected graph being associated and belonging to the same user. In this embodiment, the user relationship indicated between each ID and the credibility index of each data source may be automatically extracted, and the user relationship graph is regulated according to the credibility indexes, so that unreasonable user ID recognition is avoided to improve an ID merging rate and accuracy of user recognition and further solve the technical problem of relatively low accuracy in recognition of IDs of the same user in the related art.

In an optional embodiment, ID association apparatus further includes: a first acquisition element, configured to, before reading the user information, acquire IDs of each user in the multiple data sources, different combination forms being adopted for the IDs of each data source; and a recording element, configured to perform at least one of the following, operations: when determining that two IDs in the same time period belong to the same user, record a first representation form of the two IDs; when determining that two IDs in the same time period are used for executing the same operation and the two IDs belong to the same user, record a second representation form of the two IDs; and, when determining that one ID in the same time period is used for executing a target operation, record a third representation form of the one ID.

In an optional embodiment, the extraction element includes: a first extraction component, configured to extract a first user relationship from the first representation form of the two IDs and the second representation form of the two IDs and determine a first initial credibility index of a data source corresponding to the first user relationship, the first user relationship indicating the data source and, a user relationship indicated between each two IDs; a second extraction component, configured to extract a second user relationship from the second representation form of the two IDs and the third representation form of the one ID and determine a second initial credibility index of a data source corresponding to the second user relationship; and a third extraction component, configured to extract a third user relationship from the second representation form of the two IDs and the third representation form of the one ID and determine a third initial credibility index of a data source corresponding to the third user relationship.

In an optional embodiment, the second extraction component includes: a first arrangement subcomponent, configured to arrange the user information according to an acquired time sequence; a first detection subcomponent, configured to detect each time window after arranging the user information, a first, time period being added to a present detection time point every time when a time window is detected; and a first determination subcomponent, configured to, when two IDs in the user information are different and the two IDs in the time window are used for executing different operations, determine the second user relationship and determine the second initial credibility index of the data source corresponding to the second user relationship.

In an optional embodiment, the third extraction component includes: a second arrangement subcomponent, configured to arrange the user information according to the acquired time sequence; a second detection subcomponent, configured to detect each time window after arranging the user information, a second time period being added to a present detection time point every time when a time window is detected; and a second determination subcomponent, configured to, when two IDs in the user information are different and a ratio value that the two IDs in the time window are used for executing the same operation is higher than a preset ratio value, determine the third user relationship and determine the third initial credibility index of the data source corresponding to the third user relationship.

In an optional embodiment, the construction element includes: a first determination component, configured to determine each ID as a point and create a connecting edge corresponding to each user relationship; a calculation component, configured to calculate credibility of each connecting edge according to the credibility index of each data source, a time decay coefficient of credibility of the user relationship and a time difference value between a time point when the user relationship occurs and a present time point; a first sequencing component, configured to perform sequencing according to the credibility to obtain a sequencing result; and a construction component, configured to, after performing sequencing, add each connecting edge into the user relationship graph according to the sequencing result to construct the user relationship graph, one connecting path being between every two points in the user relationship graph.

In an optional embodiment, the construction element further includes: a second determination component, configured to, when determining that the user relationship is a first user relationship or a third user relationship, determine the connecting edge corresponding to the user relationship as a first-type edge, two IDs indicated by the first-type edge belonging to the same user; and a third determination component, configured to, when determining that the user relationship is a second user relationship, determine the connecting edge corresponding to the user relationship as a second-type edge, the two IDs indicated by the second-type edge not belonging to the same user.

In an optional embodiment, the determination element includes: a fourth determination component, configured to determine a first credibility index variation of each connecting edge and a second credibility index variation of each data source; a regulation component, configured to regulate the credibility index of each data source according to the first credibility index variation and the second credibility index variation; and a fifth determination component, configured to regulate the user relationship graph according to the regulated credibility index to determine the ID connected graph of each user.

In an optional embodiment, the fourth determination component includes: a third determination subcomponent, configured to, for a connecting edge that is not added to the user relationship graph, determine a first credibility index sub-variation according to a type of the connecting edge; an accumulation subcomponent, configured to, for a connecting edge that has been added to the user relationship graph, accumulate a credibility index variation to obtain a second credibility index sub-variation; and a fourth determination subcomponent, configured to determine the first credibility index variation according to the first credibility index sub-variation and the second credibility index sub-variation.

In an optional embodiment, the fifth determination component includes: a second acquisition subcomponent, configured to acquire a point number of each maximal connected branch in the user relationship graph, the maximal connected branch including multiple points; a third acquisition subcomponent, configured to, when determining that the point number of the maximal connected branch exceeds a preset point number, obtain an ID code corresponding to the maximal connected branch, the ID code being obtained by encrypting a result for splicing a data source of each of all IDs in the maximal connected branch and all IDs in the maximal connected branch, and the ID code indicating that all of the IDs in the maximal connected branch belong to the same user; and a fifth determination subcomponent, configured to determine the maximal connected branch indicated by the ID code as an ID connected branch of the same user to determine the ID connected graph corresponding to each user.

In an optional embodiment, the ID association apparatus further includes: a second acquisition element, configured to, after the ID connected graph of each user is determined, acquire new user information; an analysis element, configured to analyze the new user information to determine a new connecting edge; a second extraction element, configured to extract a new ID code belonging to the same user according to the new connecting edge; and an access element, configured to access an ID code maintenance table, and when determining that an old ID code in the ID code maintenance table is the same as the new ID code, merge the old ID code and the new ID code, and determining that a user indicated by the old ID code and a user indicated by the new ID code are the same user, the ID code maintenance table recording modification information of ID codes.

In an optional embodiment, the ID association apparatus further includes: a cleaning element, configured to, after the user information is read, are used for executing a cleaning operation on the user information, the cleaning operation at least including data format cleaning and numerical range exception cleaning, the data format cleaning indicating cleaning of data inconsistent with a preset data format and the numerical range exception cleaning indicating cleaning of data inconsistent with the representation forms of the IDs.

The ID association apparatus may further include a processor and a memory. All of the reading element 41, the extraction element 43, the construction element 45, the determination element 47 and the like are stored in the memory as program elements, and the processor is used for executing the program elements stored in the memory to realize corresponding functions.

The processor includes a core, and the core calls the corresponding program element in the memory. There may be one or more cores, and the ID connected graph of each user is determined by regulating core parameters.

The memory may include forms such as a nonvolatile memory, Random Access Memory (RAM) and/or nonvolatile memory in a computer-readable medium, for example, a Read-Only Memory (ROM) or a flash RAM, and the memory includes, at least one storage chip.

In another embodiment of the present disclosure, an electronic device is also provided, which includes: a processor; and a memory, configured to store at least one executable instruction of the processor, the processor being configured to execute the at least one executable instruction to execute above-mentioned ID association method.

In another embodiment of the present disclosure, a storage medium is also provided, which includes a stored program, the stored program running to control a device where the storage medium is located to execute above-mentioned ID association method.

The sequence numbers of the embodiments of the present disclosure are adopted for description and do not represent superiority-inferiority of the embodiments.

In the embodiments of the present disclosure, the descriptions of the embodiments focus on different aspects. The part which is not described in a certain embodiment in detail may refer to the related description of the other embodiments.

In some embodiments provided in the application, it should be understood that the disclosed technical contents may be implemented in other manners. Herein, the device embodiment described above is only schematic. For example, division of the elements is division of logical functions, and other division manners may be adopted during practical implementation. For example, multiple elements or components may be combined or integrated to another system, or some features may be ignored or are not executed.

The elements described as separate parts may or may not be separate physically, and parts displayed as elements may or may not be physical elements, that is, they may be located in the same place, or may also be distributed to multiple elements. Part or all of the elements may be selected to achieve the purpose of the solutions of the embodiments according to a practical requirement.

In addition, each functional element in each embodiment of the present disclosure may be integrated into a processing element, each element may also physically exist independently, and two or more than two elements may also be integrated into a element. The integrated element may be implemented in a hardware form and may also be implemented in form of software functional element.

When being implemented in form of software functional element, and sold or used as an independent product, the integrated element may be stored in a computer-readable storage medium. Based on such an understanding, the technical solutions of the present disclosure substantially or parts making contributions to the conventional art or all or part of the technical solutions may be embodied in form of software product. The computer software product is stored in a storage medium, including a plurality of instructions configured to enable a computer device (which may be a personal computer, a server, a network device or the like) to are used for executing all or part of the steps of the method in each embodiment of the present disclosure. The storage medium includes various media capable of storing program codes such as a U disk, a ROM, a RAM, a mobile hard disk, a magnetic disk or an optical disk.

The above are the exemplary embodiments of the present disclosure. It is to be pointed out that those of ordinary skill in the art may also make a number of improvements and embellishments without departing from the principle of the present disclosure and these improvements and embellishments shall also fall within the scope of, protection of the present disclosure.

### INDUSTRIAL APPLICABILITY

The solutions provided in the embodiments of the present disclosure may be applied to recognition about whether user IDs belong to the same user or not. The technical solutions provided in the embodiments of the present disclosure may be applied to a terminal communication device. When a display panel actually runs, brightness of a screen of the display panel may be regulated in real time, and the credibility of the data sources are automatically regulate to avoid unreasonable user ID recognition to improve an ID merging rate and accuracy of user recognition and further solve the technical problem of relatively low accuracy in recognition of IDs of the same user in the related art. In the embodiments of the present disclosure, the user relationship indicated between each two IDs and the credibility index of each data source may be automatically extracted, and the user relationship graph is regulated according to the credibility index, so that unreasonable user ID recognition is avoided to improve the ID merging rate and accuracy of user recognition.

What is claimed is:

1. An Identifier (ID) association method, comprising:
reading user information, the user information comprising representation forms of IDs of a plurality of data sources;
extracting a user relationship indicated between each two IDs and a credibility index of each data source according to the representation forms of the IDs of the plurality of data sources;
constructing a user relationship graph, the user relationship graph taking each ID as a point and taking the user relationship as a connecting edge; and
regulating the user relationship graph according to the credibility index to determine an ID connected graph of each user, each ID in the ID connected graph being associated and belonging to the same user.

2. The ID association method as claimed in claim 1, before reading the user information, further comprising:
acquiring IDs of each user in the plurality of data sources, different combination forms being adopted for the IDs of each data source; and
performing at least one of the following operations:
when determining that two IDs in the same time period belong to the same user, recording a first representation form of the two IDs;
when determining that two IDs in the same time period are used for executing the same operation and the two IDs belong to the same user, recording a second representation form of the two IDs; and,
when determining that one ID in the same time period is used for executing a target operation, recording a third representation form of the one ID.

3. The ID association method as claimed in claim 2, wherein extracting the user relationship indicated between each two IDs and the credibility index of each data source according to the representation forms of the IDs of the plurality of data sources comprises at least one of the following operations:
extracting a first user relationship from the first representation form of the two IDs and the second representation form of the two IDs, and determining a first initial credibility index of a data source corresponding to the first user relationship, the first user relationship indicating the data source and a user relationship indicated between each two IDs;
extracting a second user relationship from the second representation form of the two IDs and the third representation form of the one ID, and determining a second initial credibility index of a data source corresponding to the second user relationship; and
extracting a third user relationship from the second representation form of the two IDs and the third representation form of the one ID, and determining a third initial credibility index of a data source corresponding to the third user relationship.

4. The ID association method as claimed in claim 3, wherein extracting the second user relationship from the second representation form of the two IDs and the third representation form of the one ID and determining the second initial credibility index of the data source corresponding to the second user relationship comprises:
arranging the user information according to an acquired time sequence;
detecting each time window after arranging the user information, a first time period being added to a present detection time point every time when a time window is detected; and
when two IDs in the user information are different and the two IDs in the time window are used for executing different operations, determining the second user relationship and determining the second initial credibility index of the data source corresponding to the second user relationship.

5. The ID association method as claimed in claim 3, wherein extracting the third user relationship from the second representation form of the two IDs and the third representation form of the one ID and determining the third initial credibility index of the data source corresponding to the third user relationship comprises:
arranging the user information according to an acquired time sequence;
detecting each time window after arranging the user information, a second time period being added to a present detection time point every time when a time window is detected; and
when two IDs in the user information are different and a ratio value that the two IDs in the time window are used for executing the same operation is higher than a preset ratio value, determining the third user relationship and determining the third initial credibility index of the data source corresponding to the third user relationship.

6. The ID association method as claimed in claim 1, wherein constructing the user relationship graph comprises:
determining each ID as a point and creating a connecting edge corresponding to each user relationship;
calculating credibility of each connecting edge according to the credibility index of each data source, a time decay coefficient of credibility of the user relationship and a time difference value between a time point when the user relationship occurs and a present time point;
performing sequencing according to the credibility to obtain a sequencing result; and
after performing sequencing, adding each connecting edge into the user relationship graph according to the sequencing result to construct the user relationship graph, one connecting path being between every two points in the user relationship graph.

7. The ID association method as claimed in claim 6, wherein constructing the user relationship graph further comprises:
when determining that the user relationship is a first user relationship or a third user relationship, determining the connecting edge corresponding to the user relationship as a first-type edge, two IDs indicated by the first-type edge belonging to the same user, and
when determining that the user relationship is a second user relationship, determining the connecting edge corresponding to the user relationship as a second-type edge, the two IDs indicated by the second-type edge not belonging to the same user.

8. The ID association method as claimed in claim 1, wherein regulating the user relationship graph according to the credibility index to determine the ID connected graph of each user comprises:
determining a first credibility index variation of each connecting edge and a second credibility index variation of each data source;
regulating the credibility index of each data source according to the first credibility index variation and the second credibility index variation; and
regulating the user relationship graph according to the regulated credibility index to determine the ID connected graph of each user.

9. The ID association method as claimed in claim 8, wherein determining the first credibility index variation of each connecting edge comprises:
for a connecting edge that is not added to the user relationship graph, determining a first credibility index sub-variation according to a type of the connecting edge;
for a connecting edge that has been added to the user relationship graph, accumulating a credibility index variation to obtain a second credibility index sub-variation; and
determining the first credibility index variation according to the first credibility index sub-variation and the second credibility index sub-variation.

10. The ID association method as claimed in claim 8, wherein determining the ID connected graph of each user comprises:
acquiring a point number of each maximal connected branch in the user relationship graph, the maximal connected branch comprising a plurality of points;
when determining that the point number of the maximal connected branch exceeds a preset point number, obtaining an ID code corresponding to the maximal connected branch, the ID code being obtained by encrypting a result for splicing a data source of each of all IDs in the maximal connected branch and all IDs in the maximal connected branch, and the ID code indicating that all IDs in the maximal connected branch belong to the same user; and
determining the maximal connected branch indicated by the ID code as an ID connected branch of the same user to determine the ID connected graph corresponding to each user.

11. The ID association method as claimed in claim 10, after determining the ID connected graph of each user, further comprising:
acquiring new user information;
analyzing the new user information to determine a new connecting edge;
extracting a new ID code belonging to the same user according to the new connecting edge; and
accessing an ID code maintenance table, and when determining that an old ID code in the ID code maintenance table is the same as the new ID code, merging the old ID code and the new ID code, and determining that a user indicated by the old ID code and a user indicated by the new ID code are the same user, the ID code maintenance table recording modification information of ID codes.

12. The ID association method as claimed in claim 1, after reading the user information, further comprising:
executing a cleaning operation on the user information, the cleaning operation at least comprising data format cleaning and numerical range exception cleaning, the data format cleaning indicating cleaning of data inconsistent with a preset data format and the numerical range exception cleaning indicating cleaning of data inconsistent with the representation forms of the IDs.

13. An Identifier (ID) association apparatus, comprising:
a reading element, configured to read user information, the user information comprising representation forms of IDs of a plurality of data sources;
an extraction element, configured to extract a user relationship indicated between each two IDs and a credibility index of each data source according to the representation forms of the IDs of the plurality of data sources;
a construction element, configured to construct a user relationship graph, the user relationship graph taking each ID as a point and taking the user relationship as a connecting edge; and
a determination element, configured to regulate the user relationship graph according to the credibility indexes to determine an ID connected graph of each user, each ID in the ID connected graph being associated and belonging to the same user.

14. An electronic device, comprising:
a processor; and
a memory, configured to store at least one executable instruction of the processor,
the processor being configured to execute the at least one executable instruction to execute the ID association method as claimed in claim 1.

15. A storage medium, comprising a stored program, the stored program running to control a device where the storage medium is located to execute the ID association method as claimed in claim 1.
